(19) United States
(12) Patent Application Publication
(10) Pub. No.: US 2024/0082841 A1
(43) Pub. Date: Mar. 14, 2024

(54) GLASS ARTICLES INCLUDING FLOW CHANNELS AND METHODS OF MAKING THE SAME

(71) Applicant: CORNING INCORPORATED, CORNING, NY (US)

(72) Inventors: Jonathan Paul Icenhower, Elmira, NY (US); Jin Su Kim, Seoul (KR); Xinyuan Liu, San Jose, CA (US)

(21) Appl. No.: 17/766,867

(22) PCT Filed: Oct. 13, 2020
(86) PCT No.: PCT/US2020/055310

§ 371 Date: Apr. 6, 2022

Related U.S. Application Data
(60) Provisional application No. 62/924,878, filed on Oct. 23, 2019.

(51) Int. Cl. B01L 3/00

(52) U.S. Cl. CPC B01L 3/502761; B01L 3/502707; B01L 2200/0647; B01L 2200/12; B01L 2200/16; B01L 2300/0654; B01L 2300/165

(57) ABSTRACT

Glass articles including a glass laminate substrate having a plurality of flow channels formed therein are provided. The glass laminate substrate includes a first glass layer and a second glass layer fused together. In various embodiments, at least 80% of a total area of a floor of each of the flow channels has a local surface flatness of less than 100 nm/mm², measured along a length and width of the floor of each of the plurality of flow channels Such glass articles are manufactured using a method including contacting a first portion of the first glass layer with a first etchant for a first etch time to at least partially form flow channels in the glass substrate and contacting the flow channels with a second etchant for a second etch time to flatten a floor of each of the flow channels.

### CROSS-REFERENCE TO RELATED APPLICATIONS

This application claims the benefit of priority under 35 U.S.C. § 119 of U.S. Provisional Application No. 62/924,878, filed Oct. 23, 2019, the content of which is incorporated herein by reference in its entirety.

### FIELD

The present specification generally relates to glass articles including flow channels therein and, in particular, glass laminate substrates having a plurality of flow channels extending through a first layer of the glass laminate.

### TECHNICAL BACKGROUND

Microfluidic, or flow cell, devices may be useful for a variety of applications including bio-analysis (e.g., nucleic acid sequencing, single molecule analysis, etc.). In various applications, analysis employs high-resolution fluorescence imaging techniques to identify and quantify specific molecules at a surface of a substrate that is exposed to the flow channel of the device. For example, in optical detection based parallel gene sequencing techniques, millions of DNA fragments generated from a genomic DNA sample may be immobilized and partitioned onto the substrate surface of the flow cell device such that the fragments are spatially separated from each other to facilitate sequencing by, for example, synthesis, ligation, or single-molecule real-time imaging.

Conventional bio-analysis techniques employing these nucleic acid sequencing and single molecule assays often suffer from prolonged collection times for collecting thousands of images to achieve adequate identification and quantification.

Accordingly, a need in the art exists for improved flow cell devices which can aid in reduced image collection time.

### SUMMARY

According to a first aspect, a glass article comprises a glass laminate substrate comprising a first glass layer and a second glass layer fused to the first glass layer, and a plurality of flow channels extending through the first glass layer to the second glass layer, wherein at least 80% of a total area of a floor of each of the plurality of flow channels has a local surface flatness of less than 100 nm/mm², measured along a length and width of the floor of each of the plurality of flow channels.

According to a second aspect, a glass article includes the glass article according to the first aspect, wherein the first glass layer is fused to a first major surface of the second glass layer, and wherein the glass laminate substrate further comprises a third glass layer fused to a second major surface of the second glass layer opposite the first major surface.

According to a third aspect, a glass article includes the glass article according to any preceding aspect, wherein the length of the floor of each of the flow channels is greater than 10 mm.

According to a fourth aspect, a glass article includes the glass article according to any preceding aspect, wherein the length of the floor of each of the flow channels is greater than 20 mm.

According to a fifth aspect, a glass article includes the glass article according to any preceding aspect, wherein the width of the floor of each of the flow channels is greater than 1 mm.

According to a sixth aspect, a glass article includes the glass article according to any preceding aspect, wherein the width of the floor of each of the flow channels is greater than 1.5 mm.

According to a seventh aspect, a glass article includes the glass article according to any preceding aspect, wherein at least 90% of the total area of the floor of each of the plurality of flow channels has a local average surface flatness of less than 100 nm/mm².

According to an eighth aspect, a glass article includes the glass article according to any preceding aspect, wherein at least 95% of the total area of the floor of each of the plurality of flow channels has a local average surface flatness of less than 100 nm/mm².

According to a ninth aspect, a glass article includes the glass article according to any preceding aspect, wherein the first glass layer defines sidewalls of each of the plurality of flow channels and the second glass layer defines the floor of each of the plurality of flow channels.

According to a tenth aspect, a glass article includes the glass article according to any preceding aspect, wherein the plurality of flow channels is 50 flow channels.

According to an eleventh aspect, a microfluidic device comprises the glass article according to any preceding aspect and a cover bonded to the glass article and at least partially covering the flow channel

According to a twelfth aspect, a microfluidic device comprises the microfluidic device according to the eleventh aspect, wherein the microfluidic device is a flow cell for DNA sequencing.

According to a thirteenth aspect, a method for manufacturing a glass article comprises depositing a masking layer on a surface of a first glass layer of a glass substrate comprising the first glass layer and a second glass layer fused to the first glass layer, whereby a masked region of the surface is covered by the masking layer, and an exposed region of the surface is uncovered by the masking layer; contacting a first portion of the first glass layer corresponding to the exposed region of the surface with a first etchant for a first etch time to remove the first portion of the glass layer to at least partially form a plurality of flow channels in the glass substrate; and contacting the plurality of flow channels with a second etchant for a second etch time to flatten a floor of each of the plurality of flow channels; wherein at least 80% of a total area of the floor of each of the plurality of flow channels has a local surface flatness of less than 100 nm/mm², measured along a length and width of the floor of each of the plurality of flow channels.

According to a fourteenth aspect, a method includes the method of the thirteenth aspect, wherein the first glass layer has a higher etch rate in the first etchant and the second etchant than the second glass layer such that the second glass layer serves as an etch stop to control a depth of each of the plurality of flow channels.

According to a fifteenth aspect, a method includes the method of the thirteenth or fourteenth aspect, wherein at least one of the first etchant and the second etchant comprises aqueous hydrofluoric acid.

According to a sixteenth aspect, a method includes the method of the fifteenth aspect, wherein the first etchant comprises aqueous hydrofluoric acid at a first concentration and the second etchant comprises aqueous hydrofluoric acid at a second concentration that is less than the first concentration.

According to a seventeenth aspect, a method includes the method of the sixteenth aspect, wherein the first concentration is from 0.2 wt % to 20 wt % HF.

According to an eighteenth aspect, a method includes the method of the sixteenth aspect, wherein the first concentration is from 0.5 wt % to 10 wt % HF.

According to a nineteenth aspect, a method includes the method of the sixteenth aspect, wherein the first concentration is from 1.5 wt % to 5 wt % HF.

According to a twentieth aspect, a method includes the method of any of the sixteenth through nineteenth aspects, wherein the second concentration is from 0.01 wt % to 5 wt % HF.

According to a twenty-first aspect, a method includes the method of any of the sixteenth through nineteenth aspects, wherein the second concentration is from 0.01 wt % to 2 wt % HF.

According to a twenty-second aspect, a method includes the method of any of the sixteenth through nineteenth aspects, wherein the second concentration is from 0.1 wt % to 0.5 wt % HF.

According to a twenty-third aspect, a method includes the method of any of the thirteenth through twenty-second aspects, wherein the glass article has at least 90% of the total area of the floor of each of the plurality of flow channels having a local surface flatness of less than 100 nm/mm², measured along a length and width of the floor of each of the plurality of flow channels.

According to a twenty-fourth aspect, a method includes the method of any of the thirteenth through twenty-third aspects, wherein the first etch time is less than or equal to an estimated amount of time to etch a depth equal to a thickness of the first glass layer.

According to a twenty-fifth aspect, a method of manufacturing a microfluidic device comprises depositing a bonding layer on a surface of a first glass layer of a glass substrate comprising the first glass layer and a second glass layer fused to the first glass layer, whereby a masked region of the surface is covered by the bonding layer, and an exposed region of the surface is uncovered by the bonding layer; contacting a first portion of the first glass layer corresponding to the exposed region of the surface with a first etchant for a first etch time to remove the first portion of the glass layer to at least partially form a plurality of flow channels in the glass substrate; contacting the plurality of flow channels with a second etchant for a second etch time to flatten a floor of each of the plurality of flow channels; and bonding a cover to the glass substrate with the bonding layer; wherein at least 80% of a total area of the floor of each of the plurality of flow channels has a local surface flatness of less than 100 nm/mm², measured along a length and width of the floor of each of the plurality of flow channels.

According to a twenty-sixth aspect, a method includes the method of the twenty-fifth aspect, wherein the first glass layer has a higher etch rate in the first etchant and the second etchant than the second glass layer such that the second glass layer serves as an etch stop to control a depth of each of the plurality of flow channels.

According to a twenty-seventh aspect, a method includes the method of the twenty-fifth or twenty-sixth aspects, wherein the first etchant comprises aqueous hydrofluoric acid at a first concentration and the second etchant comprises aqueous hydrofluoric acid at a second concentration that is less than the first concentration.

According to a twenty-eighth aspect, a method includes the method of the twenty-seventh aspect, wherein the first concentration is from 0.2 wt % to 20 wt % HF.

According to a twenty-ninth aspect, a method includes the method of the twenty-seventh aspect, wherein the first concentration is from 0.5 wt % to 10 wt % HF.

According to a thirtieth aspect, a method includes the method of the twenty-seventh aspect, wherein the first concentration is from 1.5 wt % to 5 wt % HF.

According to a thirty-first aspect, a method includes the method of any of the twenty-seventh through thirtieth aspects, wherein the second concentration is from 0.01 wt % to 5 wt % HF.

According to a thirty-second aspect, a method includes the method of any of the twenty-seventh through thirtieth aspects, wherein the second concentration is from 0.01 wt % to 2 wt % HF.

According to a thirty-third aspect, a method includes the method of any of the twenty-seventh through thirtieth aspects, wherein the second concentration is from 0.1 wt % to 1.0 wt % HF.

According to a thirty-fourth aspect, a method includes the method of any of the twenty-fifth through thirty-third aspects, wherein the glass article has at least 90% of the total area of the floor of each of the plurality of flow channels having a local surface flatness of less than 100 nm/mm², measured along a length and width of the floor of each of the plurality of flow channels.

According to a thirty-fifth aspect, a method includes the method of any of the twenty-fifth through thirty-fourth aspects, wherein the glass article has at least 95% of the total area of the floor of each of the plurality of flow channels having a local surface flatness of less than 100 nm/mm², measured along a length and width of the floor of each of the plurality of flow channels.

According to a thirty-sixth aspect, a method includes the method of any of the twenty-fifth through thirty-fourth aspects, wherein the first etch time is less than or equal to an estimated amount of time to etch a depth equal to a thickness of the first glass layer.

According to a thirty-seventh aspect, a method includes the method of any of the twenty-fifth through thirty-sixth aspects, wherein bonding the cover to the glass substrate comprises positioning the cover on the bonding layer; and irradiating the bonding layer with electromagnetic radiation sufficient to diffuse at least a portion of the bonding layer into the cover and the glass substrate, thereby bonding the cover to the glass substrate.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A is a top view of a glass article including a plurality of flow channels according to one or more embodiments shown and described herein;

FIG. 1B is a cross-sectional view of the glass article shown in FIG. 1A according to one or more embodiments shown and described herein;

FIG. 2 is a microfluidic device according to one or more embodiments shown and described herein;

FIG. 3A-3C illustrate an example method for making the glass article of FIG. 1B according to one or more embodiments shown and described herein;

FIG. 4 is a plane view schematic drawing of a multi-channeled microfluidic device according to one or more embodiments shown and described herein;

FIG. 5 is a graph illustrating the local flatness (Y-axis; in nm/mm²) as a function of etch time in 2% HF (X-axis; in min) for glass articles prepared using a single etching step;

FIG. 6 is a graph illustrating the percent within interval (PWI) (Y-axis; in % of total floor area of the flow channels) as a function of etch time in 2% HF (X-axis; in min) for glass articles prepared using a single etching step;

FIG. 7 is a graph illustrating the linear correlation between depth of removal (Y-axis; in μm) and etch time in 2% HF (X-axis; in min) for glass articles;

FIG. 8 is a graph illustrating the linear correlation between depth of removal (Y-axis; in μm) and etch time in 0.2% HF (X-axis; in min) for glass articles;

FIG. 9 is a graph illustrating local flatness (Y-axis; in nm/mm²) as a function of etch time in 0.2% HF (X-axis; in min) following an etch step in 2% HF for 37 minutes for example glass articles according to one or more embodiments shown and described herein;

FIG. 10 is a graph illustrating the percent within interval (PWI) (Y-axis; in % of total floor area of the flow channels) as a function of etch time in 0.2% HF (X-axis; in min) following an etch step in 2% HF for 37 minutes for example glass articles according to one or more embodiments shown and described herein;

FIG. 11 is a graph illustrating local flatness (Y-axis; in nm/mm²) as a function of etch time in 0.2% HF (X-axis; in min) following an etch step in 2% HF for 40 minutes for example glass articles according to one or more embodiments shown and described herein;

FIG. 12 is a graph illustrating the percent within interval (PWI) (Y-axis; in % of total floor area of the flow channels) as a function of etch time in 0.2% HF (X-axis; in min) following an etch step in 2% HF for 40 minutes for example glass articles according to one or more embodiments shown and described herein;

FIG. 13 is a multiple surface profile image for an example glass article according to one or more embodiments shown and described herein;

FIG. 14 is a graph illustrating the percent within interval (PWI) (Y-axis) for each flow channel in an example glass article according to one or more embodiments shown and described herein;

FIG. 15A is a graph illustrating the average local surface flatness (Y-axis) for flow channels in conventional glass articles and an example glass article according to one or more embodiments shown and described herein; and

FIG. 15B is a graph illustrating the average percent within interval (PWI) (Y-axis) for flow channels in conventional glass articles and an example glass article according to one or more embodiments shown and described herein.

### DETAILED DESCRIPTION

Reference will now be made in detail to various embodiments, examples of which are illustrated in the accompanying drawings. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In various embodiments, glass laminate substrates having ultra-flat floor surfaces of their flow channels are provided. The ultra-flat flow channels, and particularly the floors of the flow channels, can enable imaging processes that require less focusing time. Various embodiments also provide high consistency of flatness of the floors of the flow channels over a glass substrate or wafer.

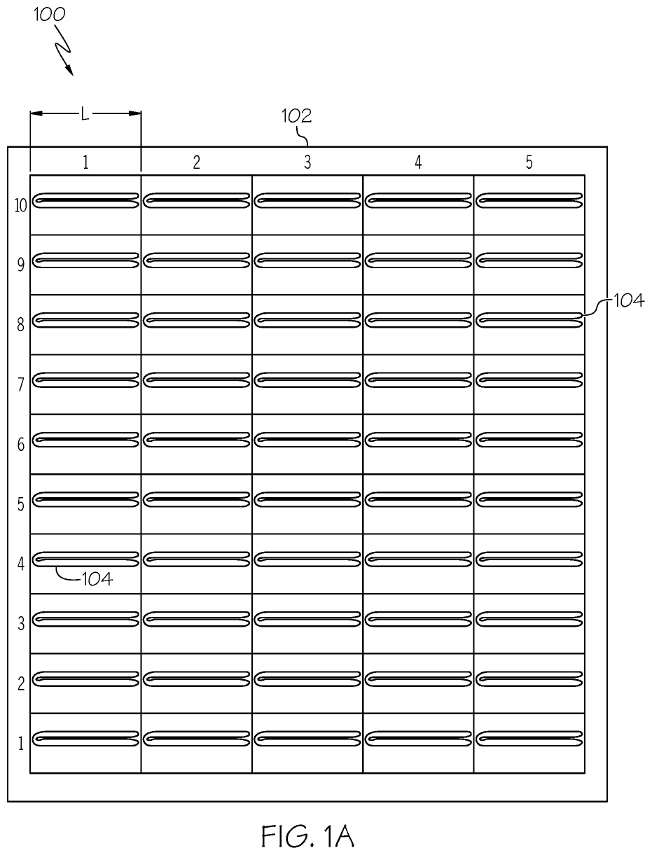

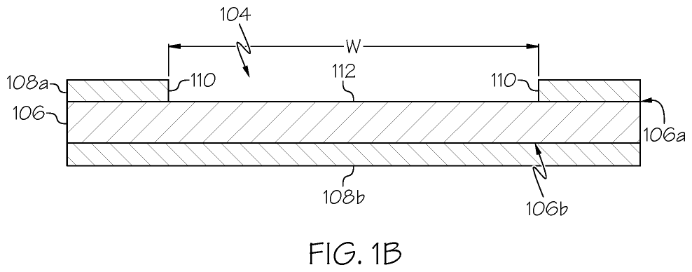

Referring now to FIG. 1A, a glass article 100 comprising a glass laminate 102 including flow channels 104 in accordance with various embodiments is shown. In particular, FIG. 1A provides a top view of a glass article 100 including a plurality of flow channels 104. In the glass article 100 shown in FIG. 1A, 50 flow channels are included, although it is contemplated that the number of flow channels included in the glass article may vary depending on the particular embodiment. For example, larger glass articles 100 may include more flow channels as compared to the glass article shown in FIG. 1A. Without being bound by theory, it is believed that including a larger number of flow channels in a glass article 100 can improve manufacturing efficiency and reduce costs, since many flow cell devices can be manufactured by separating the larger glass article 100 into smaller pieces.

FIG. 1B is a cross-section of the glass article 100 shown in FIG. 1A. As shown in FIG. 1B, the glass laminate 102 comprises a core layer 106 interposed between a first cladding layer 108a and a second cladding layer 108b.

In various embodiments, each of the glass layers, including the core layer 106, the first cladding layer 108a, and the second cladding layer 108b, comprises, independently, a glass material, including, but not limited to a glass, a glass-ceramic, a ceramic, or a combination thereof. In embodiments, the glass material of the core layer 106 is different from the glass material of the first cladding layer 108a and the second cladding layer 108b. In embodiments, the glass material of the first cladding layer 108a may be the same as the glass material of the second cladding layer 108b, or the glass material of the first cladding layer 108a may be different from the glass material of the second cladding layer 108b.

FIG. 1B illustrates the core layer 106 having a first surface 106a and a second surface 106b opposed to the first surface 106a. The first cladding layer 108a is fused directly to the first surface 106a of the core layer 106 and the second cladding layer 108b is fused directly to the second surface 106b of the core layer 106. The first and second cladding layers 108a, 108b may be fused to the core layer 106 without any additional materials, such as adhesives, polymer layers, coating layers, or the like being disposed between the glass layers. Thus, in this instance, the first surface 106a is directly adjacent the first cladding layer 108a and the second surface 106b is directly adjacent the second cladding layer 108b. In some embodiments, the glass laminate 102 is formed via a fusion lamination process (e.g., fusion draw process). Diffusive layers (not shown) may form between one or more adjacent glass layers.

In embodiments, the first and second cladding layers may be formed from a composition comprising silicon dioxide (SiO₂) having a concentration in a range of from 45 mol % to 84 mol %, alumina (Al₂O₃) having a concentration in a range of from 8 mol % to 19 mol %, boron trioxide (B₂O₃) having a concentration in a range of from 5 mol % to 23 mol %, and sodium oxide (Na₂O) having a concentration in a range of 3 mol % to 21 mol %. In some embodiments, the cladding layers may be substantially free of arsenic (As) and cadmium (Cd) to enable a difference in degradation rate between the cladding layers and the core layer 106. For example, in some embodiments, the degradation rate, or etch rate, of the cladding layers is at least ten times greater than the degradation rate, or etch rate, of the core layer in an etchant.

The first and second cladding layers of various embodiments each have a thickness of 5 μm to 300 μm, 10 μm to 275 μm, or 12 μm to 250 μm. In some embodiments, one or both of the cladding layers has a thickness of greater than 5 μm, greater than 10 μm, greater than 12 μm, greater than 15 μm, greater than 20 μm, greater than 25 μm, greater than 30 μm, greater than 40 μm, greater than 50 μm, greater than 60 μm, greater than 70 μm, greater than 80 μm, greater than 90 μm, or greater than 100 μm. In some embodiments, one or both of the cladding layers has a thickness of less than 300 μm, less than 275 μm, less than 250 μm, less than 225 μm, less than 200 μm, less than 175 μm, less than 150 μm, less than 125 μm, or less than 100 μm. The thickness of one or both of the cladding layers may be within a range formed from any of the aforementioned endpoints. It should be appreciated, however, that the cladding layers 108a, 108b can have other thicknesses.

In embodiments, the core layer may be formed from a composition comprising silicon dioxide (SiO₂) having a concentration in a range of from 60 mol % to 85 mol %, alumina (Al₂O₃) having a concentration in a range of from 1 mol % to 10 mol %, sodium oxide (Na₂O) having a concentration in a range of 3 mol % to 25 mol %, magnesium oxide (MgO) having a concentration in range of from 1 mol % to 15 mol %, and strontium oxide (SrO) having a concentration in a range of from 1 mol % to 10 mol %.

In some embodiments, the core layer 106 has a thickness of from 100 μm to 1200 μm, or from 200 μm to 1100 μm. In some embodiments, the core layer 106 has a thickness of greater than 100 μm, greater than 150 μm, greater than 200 μm, greater than 250 μm, greater than 300 μm, greater than 500 μm, greater than 600 μm, or greater than 700 μm. In some embodiments, the core layer 106 has a thickness of less than 1200 μm, less than 1000 μm, less than 900 μm, less than 800 μm, less than 700 μm, or less than 500 μm. The thickness of the core layer may be within a range formed from any of the aforementioned endpoints. It should be appreciated, however, that the core layer 106 can have other thicknesses.

As shown in FIG. 1B, each flow channel 104 is defined by two sidewalls 110 and a floor 112. In embodiments, the first cladding layer 108a defines the sidewalls 110 of each of the flow channels 104, and the core layer 106 defines the floor 112 of each of the flow channels 104. In various embodiments described herein, each flow channel 104 has a width w that is greater than 1 mm when measured from a first sidewall to a second sidewall at a central portion of the floor 112. In some embodiments, each flow channel 104 has a width w of greater than 1.5 mm. For example, each flow channel 104 may have a width w of 1 mm, 1.25 mm, 1.5 mm, 1.6 mm, 1.7 mm, 1.75 mm or greater. In various embodiments, each flow channel 104 each has a length L (shown in FIG. 1A) that is greater than 10 mm when measured at the floor 112 in a longitudinal direction at a central portion of the floor 112. In some embodiments, each flow channel 104 has a length L that is greater than 20 mm. For example, each flow channel 104 may have a length L that is 10 mm, 15 mm, 20 mm, 25 mm, 27 mm, 30 mm, or greater. Because the width w and the length L of each flow channel 104 is measured at the floor 112, these values may be referred to herein as “the width of the floor” and “the length of the floor,” respectively.

In embodiments, the floor 112 of each flow channel 104 is planar and substantially parallel to a plane defined by a top surface of the cladding layer 108a. In various embodiments, the plane of the floor 112 has an area that is at least 60%, at least 65%, at least 70%, at least 75%, at least 80%, at least 85%, at least 90%, at least 95%, or at least 98% of an area of a plane defined by the perimeter of the flow channel 104 at the top surface of the cladding layer 108a.

According to various embodiments herein, at least 80% of the total area of the floor 112 of each of the flow channels 104 has a local surface flatness of less than about 100 nm/mm² when measured along a length L and a width w of the floor 112 in each of the plurality of flow channels 104. In some embodiments, at least 90% of the total area of the floor 112 of each of the flow channels 104 has a local surface flatness of less than about 100 nm/mm², or at least 95% of the total area of the floor 112 of each of the flow channels 104 has a local surface flatness of less than about 100 nm/mm². For example, in some embodiments, from 80% to 100%, from 85% to 100%, from 90% to 100%, from 95% to 100%, from 80% to 99%, from 85% to 99%, from 90% to 99%, from 95% to 99%, from 80% to 98%, from 85% to 98%, from 90% to 98%, or from 95% to 98% of the total area of the floor 112 of each of the flow channels 104 has a local surface flatness of less than about 100 nm/mm².

The surface flatness can be measured using a laser interferometer (e.g., Tropel® FlatMaster® Multi Surface Profile (MSP) 40 using TMS™ Analysis software), which measures differences in shape and tilt between a test sample surface and reference surfaces of the interferometer. For etched flow channels, the flatness of the floor 112 of each flow channel 104 is measured relative to a bottom surface of the second cladding layer 108b or a reference substrate when the test sample is placed against the reference substrate. For bonded microfluidic devices or flow cells, the flatness of the floor 112 of each flow channel 104 is measured relative to a surface of the reference substrate, such as when the device or flow cell is placed atop the reference substrate.

In various embodiments described herein, the local surface flatness is measured by first defining a local flatness zone. In some particular embodiments, the local surface flatness of the floors of the flow channels is measured over an area of 35 mm×35 mm, and sites are scanned every 1 mm in each of the X and Y directions with a 0.5 mm increment. The local flatness zone includes all scans that include any part of the flow channel within a plane defined by a top surface of the cladding layer. In other words, if a particular scan would include the sidewall, part of the floor, and part that is not etched, the scan site is included, and the entire area of that scan site is included in the calculation of the area of the flatness zone. The laser interferometer can be used to measure the surface flatness over each of the local flatness zones and identify zones that meet a local flatness target. In various embodiments, the local flatness target is 100 nm/mm² or less. A percentage within interval (PWI) can be calculated to determine the area of the floor of each of the flow channels that has a local surface flatness that meets or is less than the local flatness target. The PWI can be calculated according to the following equation:

$$P W I = \frac{{A}_{target}}{{A}_{overall}} \times 100 ,$$

where A_{target} is the area of the floor of a flow channel that has a local flatness that is less than or equal to the local flatness target and Aₒᵥₑᵣₐₗₗ is a total area of the floor of the flow channel.

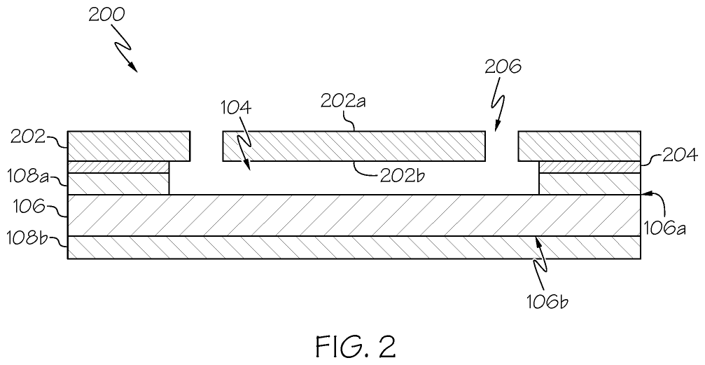

In various embodiments, the glass article 100 can be used to form a microfluidic device 200, as shown in FIG. 2. In the embodiment in FIG. 2, a glass cover substrate 202 (having a first surface 202a and a second surface 202b) is applied atop a glass-to-glass bonding material 204 and at least partially covers the flow channel 104, as will be described in greater detail herein. The glass cover substrate 202 comprises a glass material (e.g., glass, glass-ceramic, ceramic, or combinations thereof). The glass-to-glass bonding material 204 comprises at least one of Cr/CrON, metals (e.g., Zn, Ti, Ce, Pb, Fe, Va, Cr, Mn, Mg, Ge, Au, Ni, Cu, Al, Ta, Nb, Sn, In, Co, W, Yb, Zr, etc.), metal oxides thereof (e.g., Al₂O₃, ZnO₂, Ta₂O₅, Nb₂O₅, SnO₂, MgO, indium tin oxide (ITO), CeO₂, CoO, Co₃O₄, Cr₂O₃, Fe₂O₃, Fe₃O₄, In₂O₃, Mn₂O₃, NiO, a-TiO₂ (anatase), r-TiO₂ (rutile), WO₃, Y₂O₃, ZrO₂), or polymer-carbon black composite films (e.g., polyimide-carbon black film).

As a result, the second surface 202b of the glass cover substrate 202 faces and is directly opposed to the first surface 106a of the core layer 106, with the second surface 202b being a ceiling surface of the flow channel 104 and the first surface 106a being a floor surface. The ceiling surface 202b and floor surface 106a of the flow channel 104 may be highly parallel (e.g., due to precision bonding and ultra-flatness of the channel surfaces). Controlled entry and exit of a fluid (e.g., test DNA samples) can be conducted through holes 206 in the glass cover substrate 202 extending from the first surface 202a to the second surface 202b (e.g., through-holes). The flow channel 104 provides a flow path (dashed line) for the fluid through the microfluidic device. For example, when used for DNA sequencing, the flow channel 104 provides a flow path for test DNA samples such that DNA fragments may be immobilized and partitioned onto the ceiling surface 202b and/or the floor surface 106a of the flow channel 104 to facilitate sequencing. The ceiling surface 202b and/or the floor surface 106a of the flow channel 104 may be treated, for example, chemically functionalized or physically structured (e.g., with nanowell arrays), to aid in performing a desired function (e.g., capture of desired DNA fragments).

In some embodiments, although the glass laminate is described as a three-layered laminate (see FIG. 1B), a two-layered laminate is also contemplated and comprises a core glass layer and a cladding layer, as described above. Having described various embodiments of glass laminates including flow channels and microfluidic devices including the same, methods for making the glass laminates including the flow channels will now be described.

According to various embodiments, the plurality of flow channels 104 may be formed in the first cladding layer 108a of the glass laminate 102 via a two-step etching process. In various embodiments, as described above, the cladding layers 108a and 108b have a higher etch rate than the etch rate of the core layer 106, which enables the cladding layers 108a and/or 108b to be removed by the etchant while the core layer 106 serves as an etch stop.

A variety of processes may be used to produce the glass laminate 102 described herein, including, without limitation, lamination slot draw processes, lamination float processes or fusion lamination processes. Each of these lamination processes generally involves flowing a first molten glass composition, flowing a second molten glass composition, and contacting the first molten glass composition with the second molten glass composition at a temperature greater than the glass transition temperature of either glass composition to form an interface between the two compositions such that the first and second molten glass compositions fuse together at the interface as the glass cools and solidifies. In some particular embodiments, the glass laminates 102 described herein may be formed by a fusion lamination process such as the process described in U.S. Pat. No. 4,214,886, which is incorporated by reference.

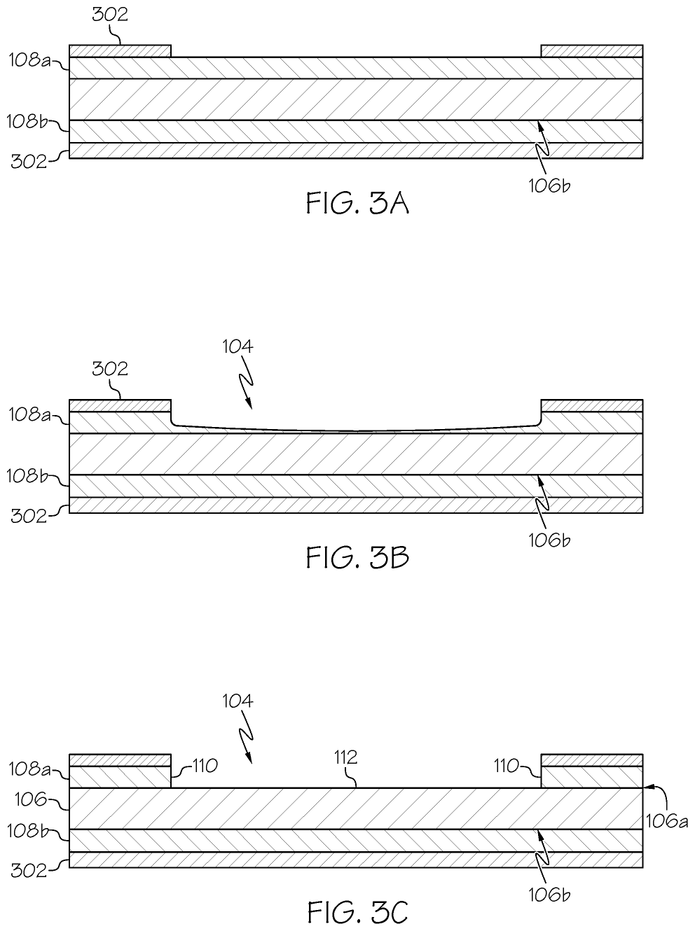

FIG. 3A-3C illustrate an example method for making the glass laminate including the flow channels described in various embodiments above. In particular, FIG. 3A illustrates a coating and patterning process whereby a masking layer 302 is deposited onto a surface of the first cladding layer 108a and the second cladding layer 108b. In some embodiments, the masking layer 302 is formed from the glass-to-glass bonding material 204 described above. In other embodiments, such as embodiments in which the masking layer 302 is not used as a glass-to-glass bonding layer, the masking layer may be formed from any material suitable for use in an etching process, such as an etch resistant polymer.

The masking layer 302 may be applied using at least one of spin-coating, dip coating, chemical vapor deposition (CVD) (e.g., plasma-assisted, atomic layer deposition (ALD), vapor-phase epitaxy (VPE), etc.), physical vapor deposition (PVD) (e.g., sputter, evaporative, e-beam, etc.), laser-assisted deposition, or other suitable methods known and used in the art to apply etch masks to glass substrates. In various embodiments, the masking layer 302 is patterned onto the glass substrate using additive or subtractive patterning techniques (e.g., ink jet printing, screen printing, tape bonding, vapor deposition, plasma etching, wet etching, etc.). The patterning of the masking layer 302 onto the glass substrate provides a masked region of the surface of the first cladding layer 108a that is covered by the masking layer 302 and an exposed region of the surface of the first cladding layer 108a that is not covered by the masking layer 302.

As shown in FIG. 3A, the masking layer 302 can be applied to the surface of the second cladding layer 108b to completely cover the surface, or it can be patterned onto the surface, as described above. In still other embodiments (not shown), no masking layer can be applied to the surface of the second cladding layer 108b, and the second cladding layer 108b can be etched away during the etching process.

After the masking layer 302 is applied, the glass laminate is contacted with a first etchant for a first etch time to remove a first portion of the first cladding layer 108a, as shown in FIG. 3B. In other words, the masked glass laminate is subjected to a wet chemical etching process to selectively remove a portion of the first cladding layer 108a that is not protected by the masking layer 302 (e.g., the portion of the first cladding layer 108a that is uncovered by the masking layer 302) to at least partially form a plurality of flow channels 104 in the glass laminate.

The first etchant is a wet etching chemical that comprises a component capable of degrading or dissolving the glass article or a portion thereof, as described herein. For example, the first etchant may include an acid (e.g., HCl, HNO₃, H₂SO₄, H₃PO₄, H₃BO₃, HBr, HClO₄, HF, acetic acid, etc.), a base (e.g., LiOH, NaOH, KOH, RbOH, CsOH, Ca(OH)₂, Sr(OH)₂, Ba(OH)₂, etc.) or a combination thereof. In various embodiments described herein, the first etchant is aqueous HF.

The first etch time can be from about 20 minutes to about 75 minutes, depending on the particular embodiment. For example, the first etch time may vary depending on the specific glass compositions used, the first etchant used, the temperature, and the amount of the first cladding layer to be removed. In some particular embodiments, the first etch time is from about 30 minutes to about 50 minutes, or from about 35 minutes to about 45 minutes.

In some embodiments, the first etch time T₁ is an amount of time that is less than or equal to an estimated amount of time T_{E} to etch a depth d equal to a thickness of the first cladding layer 108a. In some embodiments, the first etch time T₁ is an amount of time that is less than to an estimated amount of time T_{E} to etch a depth d equal to a thickness of the first cladding layer 108a. In other words, the first etch time can be selected to remove some, but not all of, the thickness of the exposed portion of the first cladding layer 108a, as shown in FIG. 3B. The estimated amount of time T_{E} to etch a depth d equal to the thickness of the first cladding layer can be determined, for example, by determining the etch rate R₁ of the first cladding layer in the first etchant and dividing the depth d by the etch rate R₁, or:

$${T}_{E} = \frac{d}{{R}_{1}}$$

In some embodiments, the first etch time T₁ is greater than about 75% of the estimated amount of time T_{E} to etch a depth d equal to the thickness of the first cladding layer, greater than about 80% of the estimated amount of time T_{E} to etch a depth d equal to the thickness of the first cladding layer, greater than about 85% of the estimated amount of time T_{E} to etch a depth d equal to the thickness of the first cladding layer, greater than about 90% of the estimated amount of time T_{E} to etch a depth d equal to the thickness of the first cladding layer, or greater than about 95% of the estimated amount of time T_{E} to etch a depth d equal to the thickness of the first cladding layer. In some embodiments, the first etch time T₁ is less than 100% of the estimated amount of time T_{E} to etch a depth d equal to the thickness of the first cladding layer, less than about 99% of the estimated amount of time T_{E} to etch a depth d equal to the thickness of the first cladding layer, less than about 98% of the estimated amount of time T_{E} to etch a depth d equal to the thickness of the first cladding layer, or less than about 95% of the estimated amount of time T_{E} to etch a depth d equal to the thickness of the first cladding layer.

Next, the glass laminate is contacted with a second etchant for a second etch time to flatten the floor of each of the plurality of flow channels, as shown in FIG. 3C. In other words, the masked glass laminate, and the partially-formed flow channels in particular, are subjected to a second wet chemical etching step to selectively remove a portion of the first cladding layer 108a that is not protected by the masking layer 302 (e.g., the portion of the first cladding layer 108a that is uncovered by the masking layer 302) complete formation of the plurality of flow channels 104 in the glass laminate. In various embodiments described herein, the etch rate R₂ of the first cladding layer in the second etchant is less than the etch rate R₁ of the first cladding layer in the first etchant. Without being bound by theory, the slower etch rate in the second etchant enables the second etchant to be used to fine tune the etching of the first cladding layer to form the plurality of flow channels and enables flow channels having flatter floors with higher reproducibility.

The second etchant is a second wet etching chemical that comprises a component capable of degrading or dissolving the glass article or a portion thereof, as described herein. For example, the second etchant may include an acid (e.g., HCl, HNO₃, H₂SO₄, H₃PO₄, H₃BO₃, HBr, HClO₄, HF, acetic acid, etc.), a base (e.g., LiOH, NaOH, KOH, RbOH, CsOH, Ca(OH)₂, Sr(OH)₂, Ba(OH)₂, etc.) or a combination thereof. The second etchant may be a different wet etching chemical than the first etchant. Additionally or alternatively, the second etchant may have a different concentration than the first etchant. For example, the first etchant and the second etchant may be the same etching chemical, but may have different concentrations. In such embodiments, the second concentration is less than the first concentration. In various embodiments described herein, the second etchant is aqueous HF. In some embodiments, the first etchant is aqueous HF at a first concentration and the second etchant is aqueous HF at a second concentration, and the second concentration is less than the first concentration. The first concentration may be, for example, from 0.2 wt % to 20 wt %, from 0.5 wt % to 10 wt %, or from 1.5 wt % to 5 wt %, and the second concentration may be, for example, from 0.01 wt % to 5 wt %, from 0.01 wt % to 2 wt %, from 0.1 wt % to 1.5 wt %, or from 0.1 wt % to 0.5 wt %.

The second etch time can be from about 15 minutes to about 75 minutes, depending on the particular embodiment. For example, the second etch time may vary depending on the specific glass compositions used, the second etchant used, the temperature, and the amount of the first cladding layer remaining to be removed. In some particular embodiments, the second etch time is from about 15 minutes to about 50 minutes, or from about 20 minutes to about 40 minutes.

As described above, in various embodiments, the core layer 106 has a lower etch rate in each of the first and second etchants than the first and second cladding layers 108a, 108b. Accordingly, the core layer 106 serves as an etch stop for the etching process steps. Moreover, in some embodiments, the second cladding layer 108b may be at least partially removed during the first and second etching steps. In some particular embodiments, the second cladding layer 108b is completely removed during the etching process steps, and the resulting glass article includes the core layer 106 and the first cladding layer 108a having a plurality of flow channels extending through the first cladding layer 108a to the core layer 106. However, in other embodiments, at least a portion of the second cladding layer 108b can be retained, such as by depositing an etch mask or other protectant thereon prior to etching. In some particular embodiments, the second cladding layer 108b is retained, and the resulting glass article includes the core layer 106, the first cladding layer 108a having a plurality of flow channels extending through the first cladding layer 108a to the core layer 106, and the second cladding layer 108b. Without being bound by theory, the use of a three-layer glass laminate substrate may eliminate the need for the use of a separate carrier to be bound to the glass article.

In various embodiments, as described above and below, a glass cover substrate 202 is applied to the glass laminate including the plurality of flow channels to form a microfluidic device, or a flow cell device, as shown in FIG. 2. In embodiments in which the masking layer 302 is formed from the glass-to-glass bonding material 204, the glass cover substrate 202 may be placed directly thereon. Alternatively, such as in embodiments in which a different masking layer 302 is employed, the masking layer may optionally be removed and the glass-to-glass bonding material 204 may be applied to the glass laminate prior to applying the glass cover substrate 202.

In some embodiments, a laser-assisted radiation bonding process may be used to bond the glass cover substrate 202 with the first cladding layer 108a using the glass-to-glass bonding material 204. Without being bound by any particular theory, it is thought that the bonding of the glass-to-glass bonding material 204 to the first cladding layer 108a and the glass cover substrate 202, respectively, is the result of diffusing a portion of the glass-to-glass bonding material 204 into the first cladding layer 108a and the glass cover substrate 202 such that each portion of the first cladding layer 108a and the glass cover substrate 202 comprising the diffused glass-to-glass-bonding material is the bonded volume layer (not shown). As oriented, the glass-to-glass bonding material 204 may not be transparent to the wavelength of the laser emission while the first cladding layer 108a and the glass cover substrate 202 may be transparent to the wavelength of the laser emission. In such embodiments, the laser emission may pass through the glass cover substrate 202 and/or the glass article 100 and be absorbed by the glass-to-glass bonding material 204. In some embodiments, the diffusion of the glass-to-glass bonding material 204 into the first cladding layer 108a and the glass cover substrate 202, respectively, renders the bonded volume layer transparent to the wavelength of laser emission.

In some embodiments, the bonding of the glass-to-glass bonding material 204 to the first cladding layer 108a and glass cover substrate 202, respectively, is accomplished using a laser which has a wavelength such that at least one of the substrates (e.g., first cladding layer 108a and/or glass cover substrate 202) is transparent to that wavelength. An interface between the layers provides a change in the index of transmission or optical transmissivity which results in absorption of laser energy at the interface and localized heating to create a bond.

In some embodiments, where the glass-to-glass bonding material 204 is Cr/CrON, the Cr component may function as a heat absorption layer which is opaque or blocking to the laser wavelength and has an affinity for diffusion into the first cladding layer 108a and/or the glass cover substrate 202. In alternative embodiments, other materials having appropriate wavelength absorption and diffusion affinity characteristics may be employed as the heat absorption layer. The thickness of the heat absorption layer may be as thick as desired to compensate for surface roughness or control timing and temperatures of the process.

Additionally, and/or alternatively, the bonding of the glass-to-glass bonding material 204 to the first cladding layer 108a and the glass cover substrate 202 throughout the bonded volume layer can include melting at least one of the glass-to-glass bonding material 204, first cladding layer 108a, and/or glass cover substrate 202 (e.g., localized melting at the site of laser emission absorption). Moreover, the bonding may also include fusing the glass-to-glass bonding material 204 to at least one of the first cladding layer 108a or glass cover substrate 202. In some embodiments, the bonded volume layer is transparent to the wavelength of the laser emission.

In some embodiments, the bonding can be achieved via separate laser emission (not illustrated), for example, as described in U.S. Pat. Nos. 9,492,990, 9,515,286, and/or 9,120,287, the entirety of which are incorporated herein by reference. In still other embodiments, adhesives or other glass-to-glass bonding materials may be employed to bond the first cladding layer 108a and the glass cover substrate 202 without the use of laser emissions.

Accordingly, in some embodiments, after the glass cover substrate 202 is placed onto the etched structure of FIG. 1B (as described above) and is in close contact with the glass-to-glass bonding material 204, the combination is exposed to radiation (e.g., laser light treatment) to bond each of the first cladding layer 108a and the glass cover substrate 202 to glass-to-glass bonding material 204 through bonded volume layers, respectively. Creating the structure of FIG. 2 may include positioning the glass cover substrate 202 on the glass-to-glass bonding material 204 and irradiating the glass-to-glass bonding material 204 with electromagnetic radiation sufficient to diffuse at least a portion of the glass-to-glass bonding material 204 into the glass cover substrate 202 and the first cladding layer 108a.

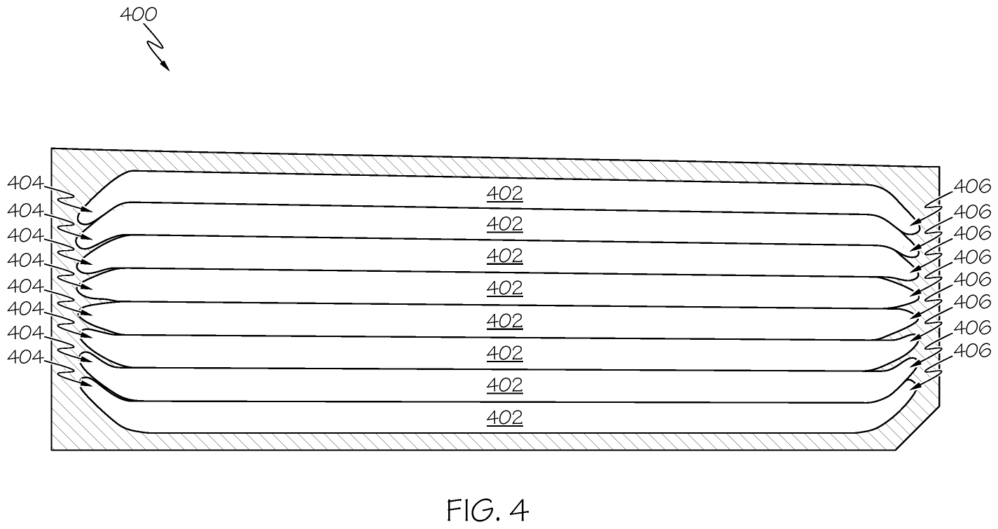

FIG. 4 is a plane view schematic drawing of a microfluidic device 400 manufactured by the methods described herein, according to some embodiments. In this example, the microfluidic device 400 includes various microfluidic channels 402, each as a flow path for test samples connecting an inlet 404 and an outlet 406 for controlled entry and exit, respectively. In other words, each of the inlet 404 and the outlet 406 are in fluid communication with the corresponding microfluidic channel 402. As described above, each microfluidic channel 402 has a floor surface being a surface of the core layer 106, a ceiling surface being a surface of the glass cover substrate 202, and the first cladding layer 108a being at least a portion of the sidewalls of the microfluidic channel 402. The ceiling and floor surfaces of each microfluidic channel 402 may be used for immobilizing biomolecules.

### EXAMPLES

In order that various embodiments be more readily understood, reference is made to the following examples, which are intended to illustrate various embodiments.

In each of the Examples described herein, the PWI refers to the area of the scanning targets meeting a local flatness target of less than 100 nm/mm² divided by the total area of the flow channel floor, multiplied by 100. Additionally, in each of the examples, the surface flatness (e.g., of the flow channels and/or the glass laminate) and total thickness variation of the glass laminate were measured using a Tropel® FlatMaster® Multi Surface Profile (MSP) 40 using TMS™ Analysis software, as described hereinabove. For local flatness measurements, an area of 35 mm×35 mm was selected for each site, and scanned every 1 mm in each of the X and Y directions with 0.5 mm increments.

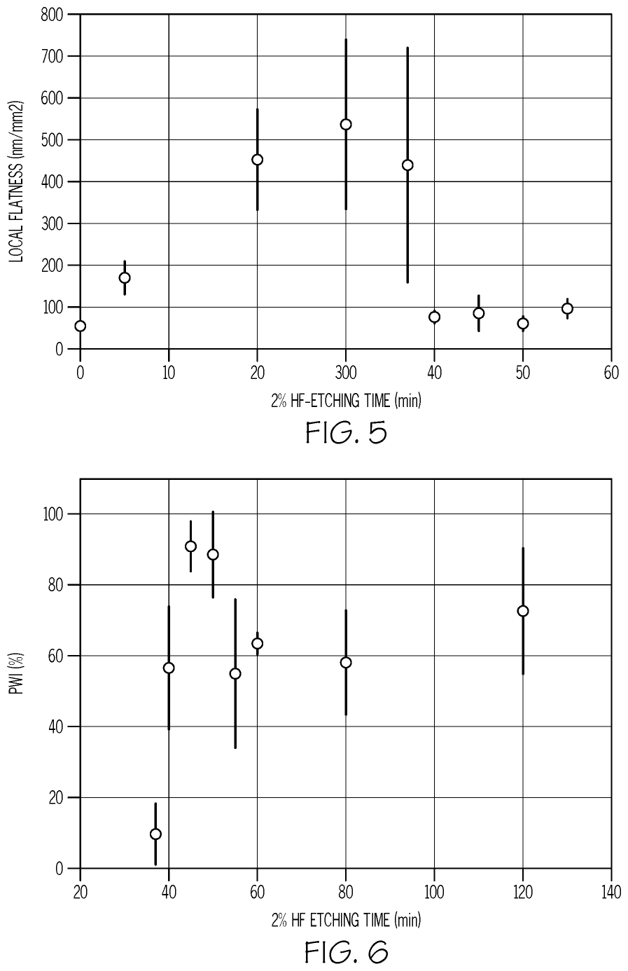

Example 1 was carried out by etching 50 flow channels into a laminate glass wafer having a composition within the ranges described herein measuring 156 mm×156 mm. The cladding layers were formed from a composition comprising SiO₂ in a range of from 45 mol % to 84 mol %, Al₂O₃ in a range of from 8 mol % to 19 mol %, B₂O₃ in a range of from 5 mol % to 23 mol %, and Na₂O in a range of 3 mol % to 21 mol %, and each cladding layer had a thickness of 100 μm. The glass wafer was masked with a patterned protective layer on the surface with channel regions uncovered. The masked glass wafer was exposed to 2% HF for various periods of time ranging from 5 minutes to 50 minutes. After etching, the protective layer was removed and the channel local flatness was evaluated using a multiple surface profiler (MSP 40, Tropel). The results are presented in FIG. 5.

As shown in FIG. 5, the local flatness increased with time until about 40 minutes. At an etch time of 40 minutes, the local flatness dropped from greater than 400 nm/mm² to less than 100 nm/mm², suggesting that as the acid dissolved the cladding layer, the cladding layer was not completely degraded until a time of about 40 minutes. At time periods of from about 40 minutes to about 55 minutes, the flatness remained about the same, suggesting the existence of an etch-stop effect as the etchant reached the core layer of the glass laminate. Accordingly, the etch-stop effect of the core layer can enable low local flatness.

The PWI was measured for targets meeting a local flatness target of less than 100 nm/mm², and the results are shown in FIG. 6. As shown in FIG. 6, at an etch time of 40 minutes, at which point the local flatness decreased significantly as demonstrated in FIG. 5, the PWI increased from 10% to 60%. FIG. 6 also shows a short processing window (roughly 5 minutes) during which a PWI of 90% was achieved between 45 and 50 minutes. According to the results shown in FIG. 6, PWI did not benefit from over-etching, as the PWI decreased after about 50 minutes. Without being bound by theory, this decrease is believed to be attributed to etching in the core layer of the glass laminate.

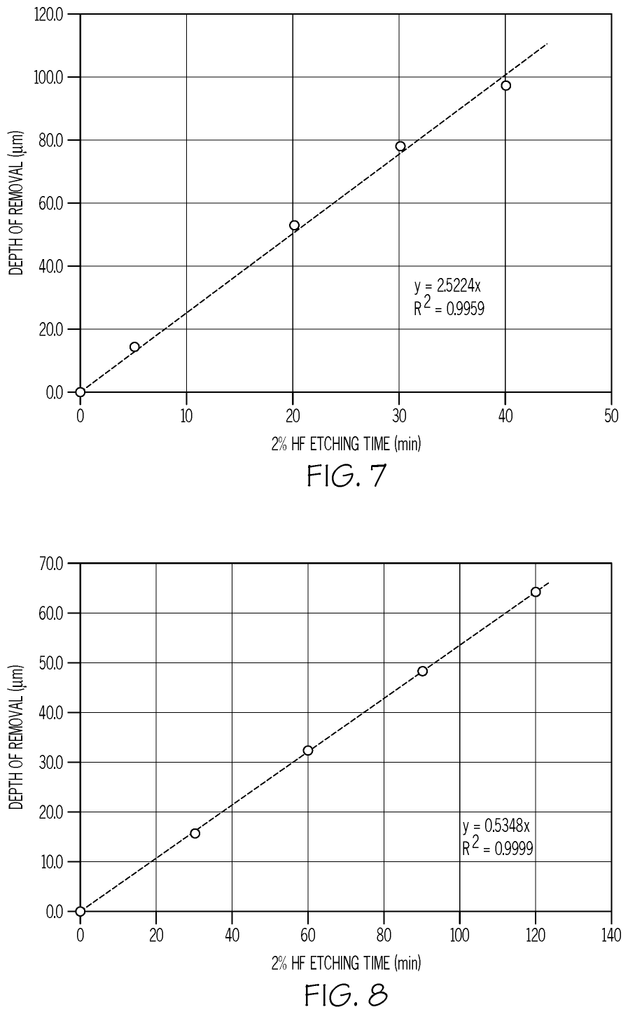

The depth of removal of the cladding layer in Example 1 was also measured over an etch time of up to 40 minutes to identify an etch rate of the sample within the 2% HF etchant. As shown in FIG. 7, a linear correlation existed between etch depth and etch time for the glass laminate in 2% HF. Based on the linear correlation, an etch rate of 2.5 μm/min was calculated for the glass laminate, and specifically, the cladding layer, in 2% HF.

Example 2 was carried out in the same manner as Example 1, except that an etchant of 0.2% HF was used to etch the flow channels. The depth of removal of the cladding layer in Example 2 was measured over an etch time of up to 120 minutes to identify an etch rate of the sample within the 0.2% HF etchant. As shown in FIG. 8, a linear correlation existed between etch depth and etch time for the glass laminate in 0.2% HF. Based on the linear correlation, an etch rate of 0.5 μm/min was calculated for the glass laminate, and specifically, the cladding layer, in 0.2% HF.

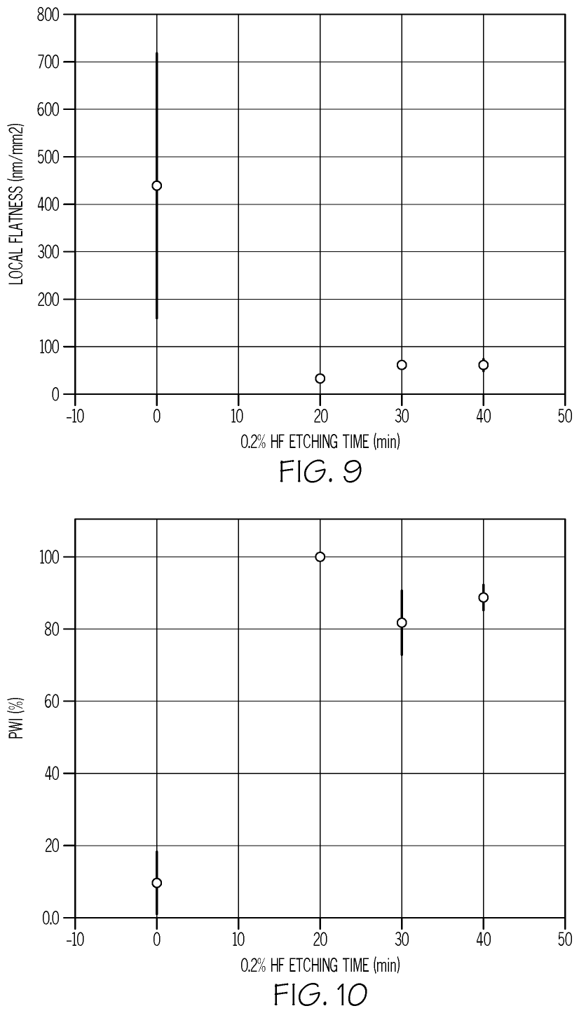

In an attempt to broaden the processing window from the window observed in Example 1 using a 2% HF etchant, Examples 3 and 4 were carried out in the same manner as Examples 1 and 2, except that the flow channels were etched using the two-step etching process described herein. In particular, the glass laminates were etched with 2% HF for 37 minutes (Example 3) or 40 minutes (Example 4) followed by etching with 0.2% HF for a time period of from 20 minutes to 40 minutes (Example 3) or 10 minutes to 30 minutes (Example 4). Local flatness and PWI were measured. The results are shown in FIGS. 9-12.

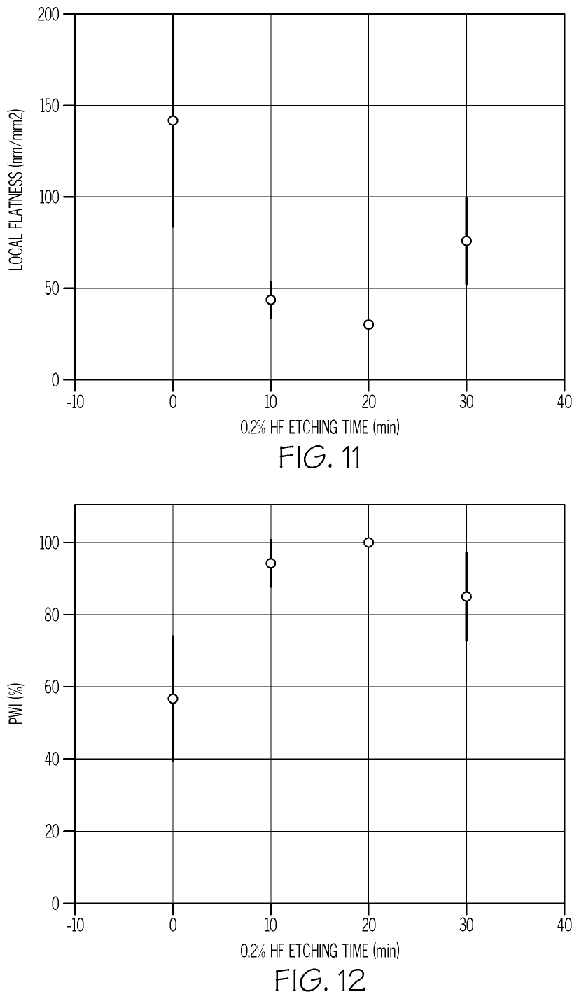

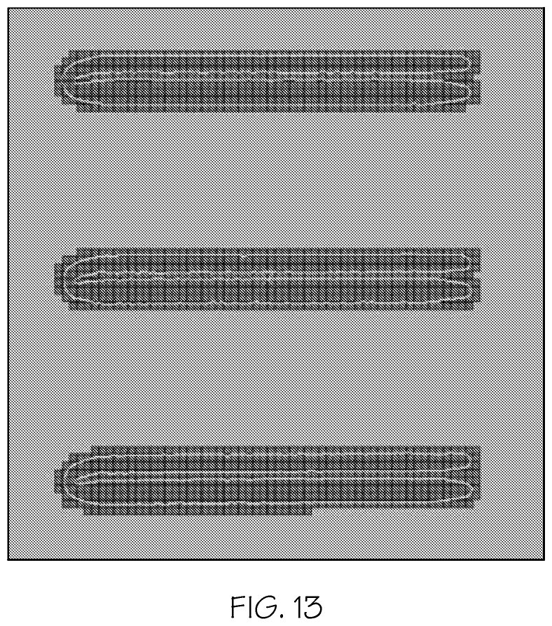

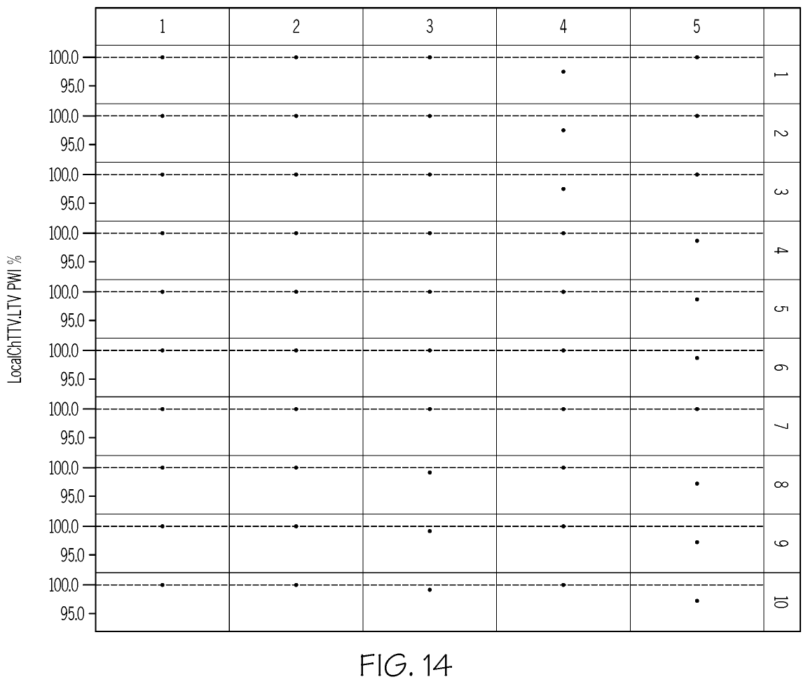

FIG. 9 illustrates the local flatness of the flow channels for a glass laminate etched using 2% HF for 37 minutes followed by 0.2% HF for a time of 20-40 minutes, and FIG. 10 illustrates the corresponding PWI for Example 3. FIG. 11 illustrates the local flatness of the flow channels for a glass laminate etched using 2% HF for 40 minutes followed by 0.2% HF for a time of 10-30 minutes, and FIG. 12 illustrates the corresponding PWI for Example 4. As shown in FIGS. 9 and 10, the two-step etching process of Example 3 reduced the local flatness from 450 nm/mm² to less than 100 nm/mm² and improved the PWI from 10% to 80-100%. FIGS. 11 and 12 show that the two-step etching process of Example 4 reduced the local flatness from 150 nm/mm² to less than 100 nm/mm² and improved the PWI from 60% to 80-100%. Compared to the 5 minute processing window observed in Example 1, the two-step etching process enables a broader process window of at least 20 minutes.

A multiple surface profile (MSP) image (FIG. 13) was taken showing three flow channels of a glass substrate etched for 37 minutes using 2 wt % HF followed by 20 minutes using 0.2 wt % HF. In FIG. 13, shaded boxes correspond to area samples that meet a target local flatness of less than 100 nm/mm². As shown in FIG. 13, all three channels have 100% PWI for a target local flatness of less than 100 nm/mm².

A glass laminate substrate measuring 156 mm×156 mm was etched as described above for 37 minutes using 2 wt % HF followed by 20 minutes using 0.2 wt % HF to produce 50 flow channels. The PWI for each channel for a target local flatness of less than 100 nm/mm² was measured, and the results are shown in FIG. 14. As shown in FIG. 14, nearly 100% PWI was achieved in all 50 flow channels. Without being bound by theory, it is believed that the high PWI across all flow channels in the substrate can lead to a higher product yield and lower cost of production as compared to conventional methods of forming flow cell devices because flow channels having ultra-flat floors can be reliably formed across the entire length and width of the glass surface.

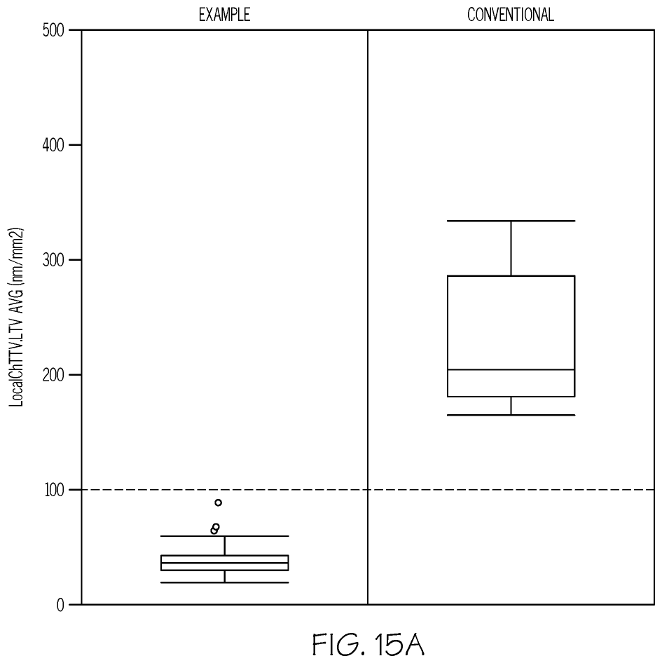

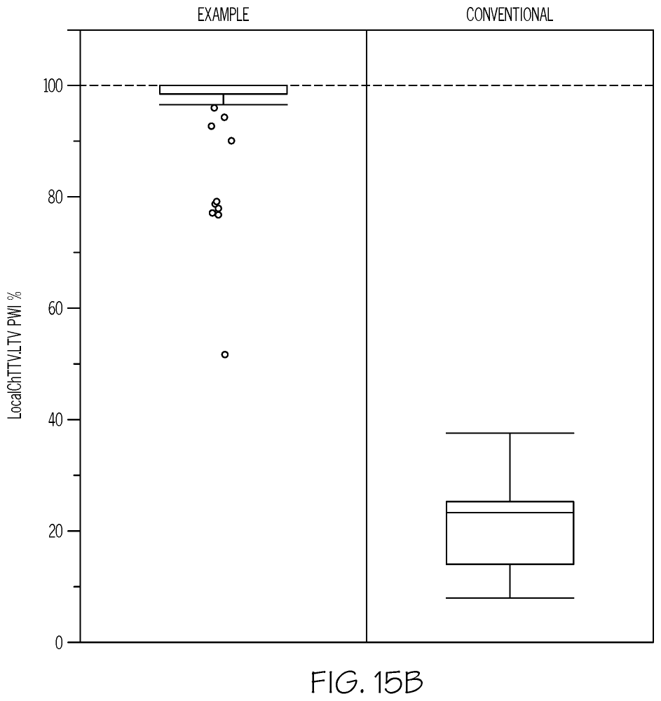

A conventional glass sample was evaluated for comparison with glass articles according to various embodiments described herein. In particular, 64 channels of a conventional glass sample and 190 channels of a glass sample made in accordance with the embodiments described herein (etching for 37 minutes with 2 wt % HF followed by etching for 20 minutes with 0.2 wt % HF) were measured for local flatness and PWI. The results are presented in FIGS. 15A and 15B. As shown in FIG. 15A, the conventional glass channels had an average local flatness of 226±62 nm/mm², while the example glass channels had an average local flatness of 38.0±11.7 nm/mm², resulting in a PWI of 21.7±8.9% for the conventional glass channels and 97.0±8.0% for the example glass channels, as shown in FIG. 15B.

In various embodiments, the resulting glass article has at least 80% of a total area of the floors of the plurality of flow channels having a local average surface flatness of less than 100 nm/mm². As a result, when the glass articles of various embodiments are used to form microfluidic devices or DNA flow cells, the glass articles described herein (e.g., having flow channels having ultra-flat surfaces) enable fast imaging acquisition due to the minimal time required for re-positioning and re-focusing imaging objectives, and/or eliminating the need for tip-tilt correction. As a result, image collection times may be significantly decreased and imaging quality is improved, thereby yielding improvement in overall assay performance for identification and quantification of biomolecule fragments.

Additionally, various embodiments described herein enable low cost in manufacturing microfluidic channels having coatings (e.g., amine reactive polymeric coatings) for covalently coupling with DNA probe molecules via their 5′- or 3′-terminal, because the density of the attached probe molecules may be precisely controlled, thereby resulting in subsequent precise control of the hybridization amount of DNA fragments containing adaptor sequence(s) complementary to the probe DNA molecules, which in turn, leads to improved polyclonal clustering and sequencing efficiency. Compared with conventional surfaces, the use of ultra-flat surfaces, and specifically, ultra-flat floor surfaces, enables calculation of the exact surface area of the flow channel, so that a specific amount of DNA molecules required to achieve the best surface density may be determined and used to functionalize the surface.

Additionally, the use of ultra-flat surfaces, and specifically, ultra-flat floor surfaces, can increase the usable width of a flow channel and decrease the volume of reagents required in sequencing and other flow cell processes.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A glass article comprising:
a glass laminate substrate comprising a first glass layer and a second glass layer fused to the first glass layer; and
a plurality of flow channels extending through the first glass layer to the second glass layer;
wherein at least 80% of a total area of a floor of each of the plurality of flow channels has a local surface flatness of less than 100 nm/mm², measured along a length and width of the floor of each of the plurality of flow channels.

2. The glass article according to claim 1, wherein the first glass layer is fused to a first major surface of the second glass layer, and wherein the glass laminate substrate further comprises a third glass layer fused to a second major surface of the second glass layer opposite the first major surface.

3. The glass article according to claim 1, wherein the length of the floor of each of the flow channels is greater than 10 mm.

4. (canceled)

5. The glass article according to claim 1, wherein the width of the floor of each of the flow channels is greater than 1 mm.

6-8. (canceled)

9. The glass article according to claim 1, wherein the first glass layer defines sidewalls of each of the plurality of flow channels and the second glass layer defines the floor of each of the plurality of flow channels.

10. (canceled)

11. A microfluidic device comprising:
the glass article according to claim 1; and
a cover bonded to the glass article and at least partially covering the flow channel.

12. (canceled)

13. A method for manufacturing a glass article, the method comprising:
depositing a masking layer on a surface of a first glass layer of a glass substrate comprising the first glass layer and a second glass layer fused to the first glass layer, whereby a masked region of the surface is covered by the masking layer, and an exposed region of the surface is uncovered by the masking layer;
contacting a first portion of the first glass layer corresponding to the exposed region of the surface with a first etchant for a first etch time to remove the first portion of the glass layer to at least partially form a plurality of flow channels in the glass substrate; and
contacting the plurality of flow channels with a second etchant for a second etch time to flatten a floor of each of the plurality of flow channels;
wherein at least 80% of a total area of the floor of each of the plurality of flow channels has a local surface flatness of less than 100 nm/mm², measured along a length and width of the floor of each of the plurality of flow channels.

14. The method according to claim 13, wherein the first glass layer has a higher etch rate in the first etchant and the second etchant than the second glass layer such that the second glass layer serves as an etch stop to control a depth of each of the plurality of flow channels.

15. The method according to claim 13, wherein at least one of the first etchant or the second etchant comprises aqueous hydrofluoric acid.

16. The method according to claim 15, wherein the first etchant comprises aqueous hydrofluoric acid at a first concentration and the second etchant comprises aqueous hydrofluoric acid at a second concentration that is less than the first concentration.

17. The method according to claim 16, wherein the first concentration is from 0.2 wt % to 20 wt % HF.

18-19. (canceled)

20. The method according to claim 16, wherein the second concentration is from 0.01 wt % to 5 wt % HF.

21-23. (canceled)

24. The method according to claim 13, wherein the first etch time is less than or equal to an estimated amount of time to etch a depth equal to a thickness of the first glass layer.

25. A method of manufacturing a microfluidic device, the method comprising:
depositing a bonding layer on a surface of a first glass layer of a glass substrate comprising the first glass layer and a second glass layer fused to the first glass layer, whereby a masked region of the surface is covered by the bonding layer, and an exposed region of the surface is uncovered by the bonding layer;
contacting a first portion of the first glass layer corresponding to the exposed region of the surface with a first etchant for a first etch time to remove the first portion of the glass layer to at least partially form a plurality of flow channels in the glass substrate;
contacting the plurality of flow channels with a second etchant for a second etch time to flatten a floor of each of the plurality of flow channels; and
bonding a cover to the glass substrate with the bonding layer;
wherein at least 80% of a total area of the floor of each of the plurality of flow channels has a local surface flatness of less than 100 nm/mm², measured along a length and width of the floor of each of the plurality of flow channels.

26. The method of claim 25, wherein the first glass layer has a higher etch rate in the first etchant and the second etchant than the second glass layer such that the second glass layer serves as an etch stop to control a depth of each of the plurality of flow channels.

27. The method according to claim 25, wherein the first etchant comprises aqueous hydrofluoric acid at a first concentration and the second etchant comprises aqueous hydrofluoric acid at a second concentration that is less than the first concentration.

28. The method according to claim 27, wherein the first concentration is from 0.2 wt % to 20 wt % HF.

29-30. (canceled)

31. The method according to claim 27, wherein the second concentration is from 0.01 wt % to 5 wt % HF.

32-35. (canceled)

36. The method according to claim 25, wherein the first etch time is less than or equal to an estimated amount of time to etch a depth equal to a thickness of the first glass layer.

37. The method according to claim 25, wherein bonding the cover to the glass substrate comprises:
positioning the cover on the bonding layer; and
irradiating the bonding layer with electromagnetic radiation sufficient to diffuse at least a portion of the bonding layer into the cover and the glass substrate, thereby bonding the cover to the glass substrate.
